(19) United States
(12) Patent Application Publication
(10) Pub. No.: US 2014/0278625 A1
(43) Pub. Date: Sep. 18, 2014

(54) METHODS AND SYSTEMS FOR VENUE PERSONALIZATION

(71) Applicant: AMI Entertainment Network, LLC, Trevose, PA (US)

(72) Inventors: Michael G. MAAS, New Hope, PA (US); Ronald RICHARDS, Elmhurst, IL (US); Stephen JAREMA, III, Pittsgrove, NJ (US); Jeffrey J. KALIS, Sparta, MI (US); William L. LAYNE, IV, Harleysville, PA (US); Robert Michael MARTIN, Holland, PA (US); Brennan MC TERNAN, Fanwood, NJ (US); Augustus John RUSSO, Blue Bell, PA (US)

(73) Assignee: AMI ENTERTAINMENT NETWORK, LLC, Trevose, PA (US)

(21) Appl. No.: 14/212,426

(22) Filed: Mar. 14, 2014

Related U.S. Application Data
(60) Provisional application No. 61/787,613, filed on Mar. 15, 2013.

(51) Int. Cl. G06Q 10/06

(52) U.S. Cl. CPC G06Q 10/0631
USPC 705/7.12

(57) ABSTRACT

A system for configuring a venue environment based on venue-specific observations is described. A controller receives inputs associated with one or more patrons of the venue. The inputs are analyzed to determine one or more environmental preferences associated with the patrons. At least one environment modification is identified based on the one or more environmental preferences. The venue environment is modified based on the identified modifications.

### CROSS-REFERENCE TO RELATED APPLICATION

This application claims the benefit of U.S. Provisional Application No. 61/787,613, filed Mar. 15, 2013.

### FIELD OF THE INVENTION

Embodiments of the present invention relate generally to venue-specific amusement device networks. More particularly, embodiments of the present invention are directed to methods and systems for modifying venue environments based on preferences, observations, and selections of, and about, venue patrons and venue staff

### BACKGROUND OF THE INVENTION

Various electronic amusement devices may be found at entertainment venues such as bars, restaurants, airports, shopping malls, video arcades, casinos, and the like. Electronic devices found at such entertainment venues include, for instance, digital and analog televisions, projectors, computer displays, portable and mobile computing devices, tablet computing devices, digital jukeboxes, and currency-operated amusement devices. The electronic devices typically are configured to output multimedia content, such as electronic games, animations, videos and audio files, or promotions.

Each of the electronic devices at a venue is preferably utilized to present content to patrons of the venue in order to enhance the patrons' experience. To achieve this goal, typically, venue staff separately controls each electronic device, or group of electronic devices. Preferably, venue staff synchronizes the content being displayed, so that the content is generally of interest to the venue patrons. Such synchronization requires significant judgment and effort on the part of venue staff and management.

Due to the separately controlled nature and one-way operation of many electronic devices, collection of observations and interactions of venue patrons with the electronic devices and with the venue is challenging. Thus, venue staff and management must do market research and venue analysis to identify the proper environment settings for patrons of the venue.

Accordingly, it would be desirable to allow venue-specific environment modifications to be made based on information about and interactions with venue patrons. It would be further desirable to attract patrons' attention to the electronic devices and to increase patrons' enjoyment of and interactivity with the electronic devices at the venue by providing a uniform experience at the venue. It would be further desirable to encourage venue owners and operators to purchase compatible equipment to add functionality to the venue, and to replace incompatible competitors' equipment and upgrade legacy equipment.

### BRIEF SUMMARY OF THE INVENTION

In one embodiment, a system for configuring a venue environment based on venue-specific observations is provided. A controller receives a plurality of inputs associated with one or more patrons of the venue. The inputs are analyzed to determine one or more environmental preferences associated with the one or more patrons of the venue. At least one environment modification is identified based on the one or more environmental preferences. The venue environment is modified based, at least in part, on the identified at least one environment modification.

In another embodiment, a system for configuring a venue environment based on venue-specific observations is described. A controller receives a plurality of inputs associated with one or more patrons of the venue and one or more inputs of venue-specific observations from venue staff The plurality of inputs regarding patrons and the one or more observational inputs are analyzed to determine an identity of at least one of the one or more patrons. At least one environment modification is identified based on the identity of the at least one patron. The venue environment is modified based, at least in part, on the identified at least one environment modification.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 is a venue-specific entertainment system according to a preferred embodiment of this invention;

FIG. 2 is a sequence diagram of communications between a venue controller and a plurality of electronic devices according to the preferred embodiment of this invention;

FIG. 3 is a sequence diagram of communications between a venue controller and a mobile device of a patron for providing suggestions to venue staff according to the preferred embodiment of this invention;

FIG. 4 is a block diagram of a system for controlling environment settings in a venue according to the preferred embodiment of this invention;

FIG. 5 is a graph of distinct types of venue modifications that may be made according to the preferred embodiment of this invention; and

FIG. 6 is a flowchart of steps for determining whether a suggestion should be automatically implemented or suggested to venue staff according to the preferred embodiment of this invention.

### DETAILED DESCRIPTION OF THE INVENTION

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

Referring to the drawings in detail, wherein like reference numerals indicate like elements throughout, FIG. 1 is an exemplary system diagram of a venue-specific entertainment system. Electronic devices 105 deployed at a venue 100 allow the venue operator to provide entertainment to venue patrons. As shown in FIG. 1, preferably at least a subset of the electronic devices 105 deployed at each venue are networked over a network 5 or otherwise communicatively coupled to a venue controller 10 at a data center 170. The network 5 may be a Local Area Network (LAN) or Wide Area Network (WAN), and may comprise portions of the Internet, and the electronic devices 105 may be connected to the network 5 by one or more network cables, or wirelessly networked, for example, by an IEEE 802.11 Wi-Fi connection, or the like.

In addition to venue controller 10, data center 170 may also house other servers, such as jukebox server 170B, game server 170C, and other servers 170D. It is to be understood that data center 170 may be spread across multiple geographic locations and that the functions of any server may be combined or distributed across physical and virtual platforms in a variety of ways known in the art within the scope of the invention.

Electronic devices 105 include currency-operated jukeboxes 130, currency-operated amusement devices 120, mobile devices 160 (e.g., smartphones or tablets), televisions 140, other computer devices 150, and the like. Other electronic devices 105 are known to those having ordinary skill in the art, and are within the scope of this invention.

In one embodiment, electronic devices 105 deployed at a venue are co-registered to the venue at which they are deployed. Preferably, the electronic devices 105 are co-registered to a venue by, for example, assigning a location or venue ID to the devices in a database that is stored in a central location, such as the data center 170. The co-registration of electronic devices 105 to a venue allows for a more uniform experience to be presented across all of the electronic devices 105 deployed at the venue.

Venue patrons, staff, and management interact with the electronic devices 105 during their presence in, around, or near the venue. Such interactions include, for example, selecting content for playback on jukeboxes 130, televisions 140, amusement devices 120 and mobile devices 160, playing electronic games on amusement devices 120 and mobile devices 160, ordering food menu items on point of sale devices (not shown), or competing in games and tournaments using amusement devices 120 and/or mobile device 160. Other interactions with the various electronic devices 105 are known to those skilled in the art, such interactions do not depart from the scope of this disclosure. Information about interactions of the venue patrons with the electronic devices 105 is preferably collected and transmitted to a venue controller 10.

The venue controller 10 is preferably a computing device, such as one or more virtual or physical servers, having one or more processors executing an operating system, memories, mass storage storing the operating system, and a wired or wireless network interface. Preferably, the venue controller 10 is located at a remote location, such as at the data center 170. In an alternative embodiment, a controller 410 (FIG. 4) may be co-located at or near the venue with the other electronic devices 105. In yet other embodiments, the functions of the controller 10 may be divided, with some of the electronic devices 105 (e.g., the televisions 140) being controlled by a controller 410 that is located at the venue, and other electronic devices 105 being controlled by a controller 10 located at the data center 170. In this case, the controller 410 deployed at the venue is preferably in communication with the controller(s) 10 at the data center 170.

Referring now to FIG. 2, a sequence diagram of communications between the controller 10 and a plurality of electronic devices A, B, and C 105a-105c is shown. The controller 10 communicates with the plurality of electronic devices A, B, and C 105a-105c by transmitting messages over the network 5 to and from the plurality of electronic devices 105a-105c deployed at the venue. Preferably, the messages are transmitted using a communication protocol such as TCP/IP, UDP, or a custom algorithm as described in the co-pending application based on Provisional Patent Application Ser. No. 61/784,252. While three electronic devices A, B and C 105a-105c are shown in FIG. 2 for exemplary purposes, the invention is not limited to any number of electronic devices 105. That is, the controller 10 may communicate with more or less electronic devices 105 at one venue, or at multiple venues, without departing from the scope of this invention.

At 230 and 232, venue patrons and/or venue staff 220 interact with the electronic devices 105a-105c in a plurality of ways. Such interactions are well known to those skilled in the art, and all interactions with electronic devices 105 are within the scope of this disclosure. For example, venue patrons may review, browse, search, share and/or select content choices to be output by the electronic devices 105, play electronic games in single player or multiplayer mode, check into a venue, transmit messages, interact with other patrons, or review and/or order food and drink menu items. Other interactions with electronic devices 105a-105c are known to those having ordinary skill in the art, and are within the scope of this invention.

At 240 and 242, data relating to patrons' interactions with the electronic devices A and B 105a, 105b is transmitted to the venue controller 10. Preferably, the transmitted data includes content selections, viewing history, settings, messages, and any other inputs made by venue patrons and/or venue staff 220 to the electronic devices A and B 105a, 105b. In many cases, the identity of individual venue patrons may be determined based on their interactions with the amusement devices 105. For example, a venue patron may log into a player account (stored on a server in data center 170) prior to playing an electronic game on an amusement device 120. Where identification information of the user(s) associated with the interactions is available, such identification information is preferably associated with the data relating to the interactions.

Where the venue controller 10 is located at a central location, such as the data center 170, the venue controller 10 preferably includes one or more servers capable of receiving, storing and processing the received interaction data. The venue controller 10 receives the first and second interactions from the electronic devices A and B 105a, 105b over the network 5.

At 250, the received interaction data is stored in one or more databases in the data center 170 that are connected to the controller 10 for aggregation and/or processing. In an alternative embodiment, where the controller 10 is deployed at a venue, the controller 10 may include internal memory for storing the interaction data. In this case, the electronic devices 105 communicate directly with the controller 10, for example, over a local area network.

In the case where collected interaction data is associated with an identified venue patron or staff member, for example, where a user ID or other identifying information is available, such patron-specific interaction data is preferably stored in the database such that the interaction data remains associated with the individual. For example, the interaction data received by the controller 10 may be stored in a player account of a venue patron if the venue patron logged into the player account prior to interacting with the amusement device 105. Similarly, interactions of staff may be stored in separate employee accounts. Alternatively, if no identifying information is available, the interaction data may generally be associated with the venue, instead of being associated with any individual user. In another embodiment, where no identifying information is available, the interaction data may be associated with an anonymous individual.

Regardless whether identifying information is available or not, the interaction data is preferably associated with the venue at which the interaction(s) with the electronic devices 105 occurred, or the venue with which the interactions are associated. Those skilled in the art will understand that multiple techniques for associating interaction data with a venue are known. In the preferred embodiment, when the controller 10 determines that the venue patron is interacting with one or more of the electronic devices 105 from the venue, the collected data is tagged with a machine ID or other identifier of the respective electronic devices 105 that are involved in the interaction. Since each electronic device 105 deployed at the venue is co-located with the venue, the machine ID is typically sufficient to establish a relationship between interactions and the venue. In another embodiment, the interaction data may be tagged with a venue ID of the venue instead of, or in addition to, the machine ID. Other interactions may be tagged based on geolocation data obtained from GPS coordinates, IP Address(es), or the like.

Returning to FIG. 2, at 252, the controller 10 aggregates the first and second interaction data received from the electronic devices A and B 105a, 105b. Since the servers at data center 170 preferably communicate with electronic devices 105 deployed at a plurality of distinct venues, one or more servers, processors or virtual processors may be assigned for aggregation and processing of data for each of the distinct venues and/or each of the distinct electronic devices 105. Furthermore, the aggregation and processing of interaction data received from the plurality of venues is preferably load-balanced across the servers of the data center 170. Preferably, the servers at the data center 170 aggregate and process the received interaction data in substantially real-time for each of the venues in communication with the data center 170.

In the preferred embodiment, for each venue in communication with the data center 170, the controller 10 only aggregates and processes data associated (e.g., tagged) with that venue. Thus, the interaction data and venue modification suggestions are preferably specific to a single venue, or to a particular geographic area associated with that venue. Therefore, suggestions for two distinct venues may be different based on the respective interactions of venue patrons at those venues, as well as any third party data, and/or venue profile(s) used in the analysis to determine the venue modification suggestions.

For example, consider the case of two neighboring sports bars. Typically, both sports bars cater to fan bases of team A. However, electronic device 105 interaction data may indicate that on a particular day, a group of fans of team B have decided to watch a contest between team A and team B at the second sports bar. In this case, the controller 10 would likely suggest environment modifications for the second sports bar to provide content on the electronic devices 105 that is relevant to fans of team B, while the venue modifications (if any) for the first sports bar would be relevant to fans of team A.

The controller 10 optionally limits the interaction data being aggregated and processed to only those interactions that occurred within a predetermined period of time. Thus, if a typical visit of a venue patron to a venue is ninety (90) minutes, interactions older than ninety (90) minutes from the present time will not be included in the analysis. In this way, the environment modification suggestions identified by the controller 10 are more likely to be relevant to the venue patrons that are currently present at the venue. In one embodiment, venue management or staff sets the amount of time during which interactions are to be included. However, preferably, the interactions to be considered by the controller 10 are automatically determined by processing interaction data to determine an average time spent at the venue by patrons. For example, a fast food restaurant may only process interactions occurring in the past forty-five (45) minutes, whereas a bar may process interactions occurring in the past one hundred twenty (120) minutes.

In one embodiment, interactions that are older than the predetermined cutoff time may still be included in the processing if the controller 10 determines that a particular venue patron that made the interactions is still present at the venue. The controller 10 may determine that the venue patron is still at the venue, for example, by identifying other, more recent, interactions of the venue patron. For example, if the controller 10 determines at time t=0 that a venue patron ordered a song to be played on the jukebox 130 at time t=−120 minutes, and then ordered a drink using his mobile device 160 at time t=−5 minutes, the interactions of that venue patron with the jukebox 130 may be included by the controller 10 in aggregating and processing the interaction data for the venue even if the interaction cutoff is one hundred twenty minutes.

Once the first and second interactions are analyzed at 254, the controller 10 identifies environment modification suggestions for the venue at 256. In identifying venue environment modification suggestions, the controller 10 preferably utilizes the received interaction data, as well as data received from one or more third party sources over the network 5. Referring to FIG. 5, environment modification suggestions may be either personal to individual patrons of the venue, or global to the venue as a whole. Furthermore, the personal and/or global environment modification suggestions may be automatically implemented, or they may be output at 260 for approval prior to implementation automatically or manually, for example, by the venue staff 220 at 262.

Where the suggestions are provided to venue staff 220, the venue staff 220 may select one or more of the suggestions to be implemented using a device such as the operator's office computer 110 (FIG. 1). Preferably, operator's office computer 110 is a tablet or other point of sale device that is accessible to the venue staff 220. For ease of operation, the operator's office computer 110 preferably includes an input device such as a touchscreen allowing venue staff 220 to review and select one or more of the suggestions to be implemented.

Returning to FIG. 2, in the case of an automatic environment modification suggestion or where the venue staff 220 selects a suggestion for implementation, at 270, the controller 10 identifies one or more actions to be performed based on the selected environment modification suggestion. For example, where the venue environment modification suggestion is “play rock music,” the controller 10 may determine that the action to be performed is to notify a jukebox 130 to select songs with the genre identifier “rock.”

Once the controller 10 determines the necessary actions to implement the venue environment modification suggestions it transmits messages to the affected electronic devices 105, causing those action(s) to be performed by the receiving electronic devices 105. Thus, returning to the example of FIG. 2, the controller 10 transmits a message relating to an action to be performed to the electronic device C 105c. Similarly, a suggestion may impact multiple electronic devices 105. For example, when a venue environment is to be modified for fans of a particular sports team, the televisions 140 may be tuned to show the game involving that sports team, and the jukebox 130 may be activated to play the sports team's fight song.

Referring to FIG. 3, in addition to, or instead of, the user interactions with electronic devices as shown in FIG. 2, suggestions for environment modifications may be based on observations relating to conditions at the venue and/or observations by venue staff 220 about patrons currently at the venue. At 320, venue staff 220 input venue-specific observations to controller 10 by, for example, using the operator's office computer 110. The observations made by venue staff 220 may include, for example, information relating to food and drink orders being placed by venue patrons; outfits worn by venue patrons (e.g., team hats, jerseys, themed t-shirts and the like), interactions between venue patrons (e.g., fans of a sports team, relationships), and demographic information about venue patrons (e.g., age, gender). Other observations relating to the venue and venue patrons made by venue staff 220 may be provided to the controller 10, such observations are known to those skilled in the art. Accordingly, any inputs, including observations of, and interactions with, venue staff 220, interactions with electronic devices 105, measurements and observations of venue sensors (e.g., thermostat(s), lighting controller(s), etc., data from third party data sources (e.g., weather data, television guide data), and observations of venue patrons may be used in providing environment modification suggestions.

Returning to FIG. 3, at 310, the first patron 330 interacts with the electronic device D 105d. For example, where the electronic device D 105d is a mobile phone, interactions may include the first patron 330 “checking into” the venue using a mobile or web application executed by the mobile phone. At 340, data about these interactions is transmitted from the electronic device D 105d to the venue controller 10.

At 344, the identity of the first patron 330 is preferably determined by the controller 10 based on, for example, account information, or other identifying information transmitted by the electronic device D 105d. At 348, once the first patron's 330 identity is determined, the identity and other background data in the profile of the first patron 330 is output to venue staff 220. Such identification allows venue staff 220 to personalize the patron's experience. For example, venue staff 220 may be able to greet the first patron 330 by their real name and/or offer the first patron 330 their favorite beverage, even if that patron has never previously had any interactions with the venue staff 220.

At 352, the controller 10 preferably identifies one or more preferences of the first patron 330 based on the interaction data and/or the venue-specific observations input by the venue staff 220. At 356, the controller 10 determines one or more suggestions for the first patron 330 based on the identified preferences. At 360, venue controller 10 outputs the environment modification suggestions to venue staff 220. At 362, venue staff 220 may select one or more of the output suggestions to be implemented at the venue, which are communicated back to the venue controller 10.

Preferably, the venue environment modifications are averaged based on the collection of venue patrons present at the venue at any given time. Therefore, new venue environment modification suggestions should not conflict with the tastes and/or preferences of the other venue patrons. At 370, in response to selection by the venue staff 220, the controller 10 causes at least one venue setting to be modified based on the selected suggestion by transmitting messages to the necessary electronic devices 105, as described with respect to FIG. 2 above.

While in the preferred embodiment, the controller 10 is located at a remote location such as the data center 170, the controller 10 may also be positioned at the same venue as the electronic devices 105, or the duties of the controller 10 may be split between a local controller 410 (FIG. 4) deployed at the venue, and a centralized controller 10 deployed at the data center 170.

Referring to FIG. 4, a plurality of venue environment settings may be remotely modified by a local controller 410 based on the venue staff 220 observations and/or the data about interactions with venue patrons. Preferably, the venue has a lighting system 420 that is controllable over a network 405 through a wired or wireless interface, as is known to those skilled in the art. For example, the lighting system 420 may be controllable through the Z-WAVE or ZIGBEE Light Link standard. ZIGBEE Light Link allows wireless control over LED fixtures, light bulbs, timers, remotes and switches. Venue temperature may be controlled by the controller 410 communicating with a network-enabled thermostat 430, such as the NEST Learning Thermostat. Other venue environment settings may be controlled by the controller 410, for example, motorized shades may be adjusted to let more or less light into the venue. Such environment modifications are known to those skilled in the art, and are within the scope of this invention.

The controller 410 also communicates with an ordering system 440 (e.g., point of sale) to transmit menu item selections over the network 405. The ordering system 440 may include information about menu items and specials that may be ordered by venue patrons. The controller 410 may also communicate with other electronic devices 105, such as amusement devices 120, digital jukebox(es) 130, and television(s) 140 to modify content being output thereon.

Whether the controller 10, 410 is located at a remote location or at the venue, environment modification suggestions are output and implemented in a similar manner. Referring to FIG. 5, environment modification suggestions may be implemented automatically by the controller 10, 410. For example, the controller 10, 410 may change the type of background music being selected by a jukebox 130 deployed at the venue. Other environment modification suggestions may be output as suggestions for venue staff 220. For example, music, food and drink preferences or favorite menu items of venue patrons may be displayed on the operators office computer 110, which is accessible to the venue staff 220. Whether a modification suggestion is implemented automatically or output to venue staff 220 as a suggestion prior to being implemented depends on settings provided by a system operator (venue manager, administrator, employees, or the like).

The system operator may be provided with the ability to set the types of venue environment modifications that are considered personal versus those that are considered global. Additionally, the system operator sets the types of modifications that should be automatically adopted, and those that should be output as suggestions to venue staff 220. In order to input these settings, a web-based user interface, such as a website accessible over the Internet or other console, is provided. Various implementations of such user interfaces are known to those skilled in the art.

Examples of the four types of venue environment modifications will now be described. Referring grid 500 of FIG. 5, the four distinct types are: personal automatic modifications 510, personal modification suggestions 520, global automatic modifications 530, and global modification suggestions 540.

Personal modifications 510 and 520 are specific to a particular venue patron. Accordingly, in most cases, personal modifications are dependent on the identity of individual venue patrons. Examples of personal modifications include changing the content being presented on a particular electronic device deployed at the venue, providing a special discount on a favorite food or drink of the venue patron, or providing information to venue staff 220 about the identity and preferences of the venue patron. Examples of personal automatic modifications include transmitting a special offer to a mobile device 160 associated with the venue patron. For example, the controller 10 may determine that an individual is a frequent visitor to the venue, and provide a free drink offer as a reward. Such special offers may be transmitted to the mobile device 160 of the venue patron without any actions being taken by venue staff 220. Examples of personal modification suggestions include outputting a notification to venue staff 220 to greet the patron by his or her first name or to prepare the patron's favorite drink.

In contrast to personal modifications, global venue environment modifications 520 or 540 are changes that affect all venue patrons. Global venue environment modifications are not dependent on the identity of any specific venue patron. Therefore, global venue environment modifications may be identified based on data about venue patrons, without information about their individual identities.

Examples of global modifications include lighting or temperature modifications for the venue. For example, management may allow automatic adjustments of venue temperature between sixty-eight (68) and seventy-two (72) degrees Fahrenheit, but require venue staff 220 approval for changes that fall outside of this range. Thus, if the controller 10 determines that the temperature should be lowered to sixty-six (66) degrees, a global modification suggestion is output by the controller 10 for approval by venue staff 220. If venue staff 220 approves the modification, the controller 10 notifies the thermostat 430 to lower the venue temperature to the desired temperature. In contrast, if the controller 10 determines that the temperature should be raised from sixty-six (66) degrees to seventy-one (71) degrees, the controller 10 may automatically implement this modification as a global automatic modification by automatically transmitting a notification to the thermostat 430.

Another example of a global modification may be a controller 10 determining that a majority of venue patrons have a particular musical preference. For example, if the controller 10 determines that patrons prefer country music, the controller 10 may transmit a notification to a music device such as the jukebox 130 deployed at the venue to cause country songs to be played when no paid songs are in the jukebox 130 play queue. Management may select one or more music genres (e.g., rock, country, oldies) that may be automatically played at the venues. In this case, prior to the controller 10 notifying the jukebox 130 to play country, the controller 10 first determines whether the selected content may be automatically played. Thus, if the controller 10 determines that hip-hop music should be played at the venue, the controller 10 first checks whether hip-hop is included in the approved types of music selected by management. If not, the controller 10 outputs a suggestion to venue staff 220 to play hip-hop music on the jukebox 130. If venue staff 220 approves this suggestion, the controller 10 notifies the jukebox 130 to play hip-hop songs when no paid songs are in the jukebox play queue.

FIG. 6 is a flowchart of steps for implementing a venue environment modification. The process starts at step 610 and proceeds to step 620, where a possible venue environment modification is identified. At step 630, it is determined whether the identified modification should be automatically implemented at the venue. If so, at step 640, the venue environment is modified with the identified modification. That is, the controller 10 automatically transmits one or more messages to the electronic devices necessary to carry out the venue environment settings modification. If the modification cannot be automatically implemented, at step 650, the identified modification is output to venue staff 220 as a suggestion. Venue staff 220 may review the environment modification suggestion and decide whether or not to implement it. At step 660, it is determined whether venue staff 220 has decided to implement the suggestion. If so, the process returns to step 640, where the venue environment is modified with the accepted suggestion. Otherwise, if venue staff 220 decides not to accept the suggestion, the process ends at step 670.

In yet another embodiment, referring to FIG. 7, the controller 10 is communicatively coupled to a knowledge base system 700. Preferably, a subscription-based system for venue environment modification is implemented though the knowledge base system 700. Subscriptions to the knowledge base system 700 are preferably offered on a venue-wide basis, and are provided for a predetermined period of time, such as one or more years. Other subscription terms and lengths are known to those skilled in the art and are within the scope of this disclosure. Preferably, only venues having active subscriptions to the knowledge base system 700 are able to receive, and implement, the venue environment modification suggestions.

In subscribing to the knowledge base system 700, venue operators (and/or staff) preferably provide information describing the venue, and venue patronage. Examples of information that may be provided includes venue type (e.g., bar, club, arcade, airport, restaurant, etc.), venue descriptor (e.g., sports bar, dive bar, airport lounge, family restaurant, etc.), gender of patrons (e.g., all male, mostly male, mostly female, all female, half male and half female), age of patrons (e.g., all ages, 18 and over, 21 and over, under 35, under 50, etc.). Other types of information about the venue and/or venue patrons, as is well known to those skilled in the art, may be provided to the knowledge base system 700 without departing from the scope of this invention.

The knowledge base system 700 preferably includes one or more databases 710 storing information collected from the electronic devices 105 either directly or through the controller 10, 410 (e.g., interaction information), as well as information collected from one or more other data sources, such as third party data sources. Preferably the knowledge base system 700 is maintained at the data center 170 together with the controller 10, but in alternate embodiments, the knowledge base system 700 may be maintained at a separate facility.

Information stored by the database 710 preferably relates to, or is associated with, the venues subscribing to the knowledge base system 700. Data sources for third party information received by the knowledge base system 700 over a network 705 include, for example, local television program guide data, demographics data, event data, sales data, weather data, available ingredients data, electric grid data, and the like. Other sources of information relating to a venue are known to those skilled in the art, and may be utilized without departing from the scope of this invention. The collected information is organized, shared, searched and utilized in order to provide suggestions for venue environment modifications. The suggestions are preferably machine-readable, for use in controlling the electronic devices 105 and/or the controller 10. However, in alternate embodiments, the suggestions formatted for human use, for example, by being output to venue staff on the operator's office computer 110.

The knowledge base system 700 preferably includes a rules engine 715 that includes a plurality of rules for processing the data stored in the database 710 for use in determining venue environment modification suggestions. Rules for venue environment modification may be created by one or more knowledge base system 700 operators and provided to the rules engine 715. For example, managers, marketers, administrators, and the like may determine rules based on subjective and objective business judgment, relevant market information, or other criteria as is known to those skilled in the art. For example, an operator defined rule may be to change the channel whenever a commercial comes on the currently displayed channel of a television 140.

The rules engine 715 may also automatically determine rules for venue environment modification suggestions based on data analytics. For example, an automatically determined rule may be determined based on previous sale information and weather information, such as offering a frozen drink special any time the local temperature is above eighty-five (85) degrees Fahrenheit. The rules, both user determined and/or automatically determined, of the rules engine 715 are applied by the knowledge base system 700 to the available data sets stored in the database 710 relating to the subscribed venue to provide suggestions for venue environment modification.

In one embodiment, some or all of the electronic devices 105 at the subscribed venue are not communicatively coupled to the controller 10, and suggestions cannot be automatically implemented by communicating (directly or indirectly) with the electronic devices 105. In this case, suggestions are preferably displayed to venue staff 220 (owners, managers, staff, etc.) on one or more electronic devices 105 at the venue, allowing the venue staff 220 to implement the venue environment modification suggestions manually. For example, where a venue environment modification suggestion is to tune to a particular channel showing a sporting event, the venue operator may use a remote control to manually tune one or more of the televisions 140 to the suggested channel. However, in the preferred embodiment, at least some of the electronic devices 105 are communicatively coupled to the controller 10. Therefore, in the preferred embodiment, the subscription-based knowledge base system automatically modifies the venue environment by outputting actions and/or suggestions to the electronic devices 105 through the controller 10.

Referring now to FIG. 8, a flowchart of steps for providing venue environment modification suggestions by the knowledge base system 700 is shown. The process begins at step 800. At step 805, one or more rules for venue environment modifications are identified by the rules engine 715. As described above, the rules may be automatically determined or input by humans. Furthermore, the rules may be global (e.g., associated with all venues) or specific to one or more venues.

At step 810, a venue is enrolled in the subscription based knowledge base system 700. At step 815, one or more data sets associated with the subscribing venue are received by the knowledge base system 700. The data sets may be received from venue electronic devices 105, venue management and/or staff, and from third parties. The received data sets are stored in the database 710 at step 820.

At step 825, one or more of the rules identified at step 805 are selected and applied to one or more of the data sets at step 830. At step 835, one or more venue environment modification suggestions are determined for the subscribing venue. At step 840, the determined venue environment modification suggestions are transmitted to a controller 10 associated with the venue for implementation at the venue. The process ends at step 845.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for configuring a venue environment based on venue-specific information, the method comprising:
receiving, by a controller, a plurality of inputs associated with one or more patrons of the venue;
analyzing the plurality of inputs associated with one or more patrons of the venue to determine one or more environmental preferences associated with the one or more patrons of the venue;
identifying at least one environment modification based on the one or more environmental preferences; and
modifying the venue environment based on the identified at least one environment modification.

2. The method of claim 1, further comprising:
receiving, by the controller, one or more inputs of venue-specific observations from venue staff.

3. The method of claim 2, wherein identifying at least one environment modification is further based upon the one or more inputs of venue-specific observations from venue staff.

4. The method of claim 1, further comprising:
presenting an indication to a user of the identified at least one environment modification based on the one or more environmental preferences; and
receiving an indication of user input indicating that the environment modification should be performed;
wherein modifying the venue environment based on the identified at least one environment modification is performed responsive to the user input indicating that the environment modification should be performed.

5. The method of claim 4, wherein presenting an indication to a user of the identified at least one environment modification based on the one or more environmental preferences is performed responsive to a determination that the identified at least one environment modification can not be made automatically.

6. The method of claim 1, wherein the controller receives the plurality of inputs from a plurality of electronic devices deployed at the venue.

7. The method of claim 6, wherein the plurality of electronic devices includes at least one mobile device.

8. The method of claim 1, wherein the at least one environment modification is selected from the list comprising temperature settings, lighting settings, sound settings, content presentation settings, drink menu options, food menu options and suggestions for venue staff

9. The method of claim 1, wherein inputs associated with one or more patrons of the venue comprise information about interactions of the venue patrons with electronic devices at the venue.

10. The method of claim 9, wherein information about interactions of the venue patrons with electronic devices at the venue comprises information related to game play, check-in, messaging, interaction with other patrons, or an order.

11. The method of claim 1, wherein at least one of the plurality of inputs is received from venue staff.

12. A method for configuring a venue environment based on venue-specific observations, the method comprising:
receiving, by a controller, a plurality of inputs associated with one or more patrons of the venue;
receiving, by the controller, one or more inputs of venue-specific observations from venue staff;
analyzing the plurality of inputs and the one or more inputs to determine an identity of at least one of the one or more patrons;
identifying at least one environment modification based on the identity of the at least one patron; and
modifying the venue environment based on the at least one environment modification.

13. The method of claim 12, wherein the controller receives the plurality of inputs from a plurality of electronic devices deployed at the venue.

14. The method of claim 12, wherein the at least one environment modification is selected from the list comprising temperature settings, lighting settings, sound settings, content presentation settings, drink menu options, food menu options and suggestions for venue staff.

15. A controller for configuring a venue environment based on venue-specific observations, comprising:
a memory for storing received data and program code;
a network interface for receiving data regarding a plurality of inputs associated with one or more patrons of the venue;
a processor for executing program code to:
analyze the data regarding a plurality of inputs associated with one or more patrons of the venue to determine one or more environmental preferences associated with the one or more patrons of the venue;
identify at least one environment modification based on the one or more environmental preferences; and
transmit data to cause modification of the venue environment based on the identified at least one environment modification.

16. The system of claim 15, wherein the processor further executes program code to:
present an indication to a user of the identified at least one environment modification based on the one or more environmental preferences; and
receive an indication of user input indicating that the environment modification should be performed;
wherein modifying the venue environment based on the identified at least one environment modification is performed responsive to the modifying the venue environment based on the identified at least one environment modification.

17. The system of claim 16, wherein presenting an indication to a user of the identified at least one environment modification based on the one or more environmental preferences is performed responsive to a determination that the environment modification cannot be made automatically.

18. The system of claim 15, wherein identifying at least one environment modification is further based upon the one or more inputs of venue-specific observations from venue staff.

19. The system of claim 15, wherein the controller receives the plurality of inputs from a plurality of electronic devices deployed at the venue.

20. The system of claim 15, wherein the at least one environment modification is selected from the list comprising temperature settings, lighting settings, sound settings, content presentation settings, drink menu options, food menu options and suggestions for venue staff
